(19) United States
(12) Patent Application Publication
(10) Pub. No.: US 2026/0281839 A1
(43) Pub. Date: Sep. 17, 2026

(54) DOWNLINK SYNCHRONIZATION ENHANCEMENT IN ENHANCED NON-TERRESTRIAL NETWORK HANDOVER

(71) Applicant: Apple Inc., Cupertino, CA (US)

(72) Inventors: Jie Cui, San Jose, CA (US); Hong He, San Jose, CA (US); Yang Tang, San Jose, CA (US); Qiming Li, Beijing (CN); Dawei Zhang, Saratoga, CA (US); Chunxuan Ye, San Diego, CA (US)

(21) Appl. No.: 19/472,562

(22) PCT Filed: Apr. 4, 2023
(86) PCT No.: PCT/CN2023/086187

§ 371 Date: Oct. 3, 2025

(51) Int. Cl. H04W 36/00; H04B 7/185; H04W 56/00

(52) U.S. Cl. CPC H04W 36/00725; H04B 7/18541; H04W 56/001

(57) ABSTRACT

A network device including a transceiver and a processor is disclosed. The processor is configured to determine a status of a target cell for handover of a user equipment (UE) from a serving network device in a serving cell to a target network device in the target cell. The serving cell and the target cell are in a non-terrestrial network (NTN). In accordance with the determined status of the target status, the processor is configured to determine whether the UE requires a downlink (DL) synchronization with the target cell, and determine a start time of scheduling the UE in the target cell without the UE performing random access channel (RACH) procedure during handover of the UE. The processor is configured to transmit, via the transceiver to the UE, and based on the determined start time of scheduling the UE in the target cell, instructions for performing the DL synchronization.

### TECHNICAL FIELD

This application relates generally to wireless communication systems, including methods and implementations of measuring and reporting channel state information (CSI).

### BACKGROUND

Wireless mobile communication technology uses various standards and protocols to transmit data between a network device (e.g., a base station, a network access point, or a relay) and a wireless communication device (e.g., a user equipment (UE)). Wireless communication system standards and protocols can include, for example, 3rd Generation Partnership Project (3GPP) long term evolution (LTE) (e.g., 4G), 3GPP new radio (NR) (e.g., 5G), and IEEE 802.11 standard for wireless local area networks (WLAN) (commonly known to industry groups as Wi-Fi®).

As contemplated by the 3GPP, different wireless communication systems standards and protocols can use various radio access networks (RANs) for communicating between a network device (e.g., a base station, a network access point, or a relay) of the RAN (which may also sometimes be referred to generally as a RAN node, a network node, or simply a node) and a wireless communication device known as a user equipment (UE). 3GPP RANs can include, for example, global system for mobile communications (GSM), enhanced data rates for GSM evolution (EDGE) RAN (GERAN), Universal Terrestrial Radio Access Network (UTRAN), Evolved Universal Terrestrial Radio Access Network (E-UTRAN), and/or Next-Generation Radio Access Network (NG-RAN).

Each RAN may use one or more radio access technologies (RATs) to perform communication between the network device and the UE. For example, the GERAN implements GSM and/or EDGE RAT, the UTRAN implements universal mobile telecommunication system (UMTS) RAT or other 3GPP RAT, the E-UTRAN implements LTE RAT (sometimes simply referred to as LTE), and NG-RAN implements NR RAT (sometimes referred to herein as 5G RAT, 5G NR RAT, or simply NR). In certain deployments, the E-UTRAN may also implement NR RAT. In certain deployments, NG-RAN may also implement LTE RAT.

A network device (e.g., a base station, a network access point, or a relay) used by a RAN may correspond to that RAN. One example of the network device may be an E-UTRAN base station, which is an Evolved Universal Terrestrial Radio Access Network (E-UTRAN) Node B (also commonly denoted as evolved Node B, enhanced Node B, eNodeB, or eNB).

Another example of the network device may be an NG-RAN base station, which is a next generation Node B (also sometimes referred to as a gNodeB or gNB).

A RAN provides its communication services with external entities through its connection to a core network (CN). For example, E-UTRAN may utilize an Evolved Packet Core (EPC), while NG-RAN may utilize a 5G Core Network (5GC).

### BRIEF DESCRIPTION OF THE SEVERAL VIEWS OF THE DRAWINGS

To easily identify the discussion of any particular element or act, the most significant digit or digits in a reference number refer to the figure number in which that element is first introduced.

FIG. 1 shows a communication system including a user equipment in communication with multiple network devices.

FIG. 2 shows an example method performed by a network device for performing a handover of a user equipment (UE), in accordance with some embodiments.

FIG. 3 shows another example method performed by a network device for performing a handover of a UE, in accordance with some embodiments.

FIG. 4 shows an example method performed by a UE for a handover of the UE, in accordance with some embodiments.

FIG. 5 illustrates an example architecture of a wireless communication system, according to embodiments disclosed herein.

FIG. 6 illustrates a system for performing signaling between a wireless device and a network device, according to embodiments disclosed herein.

### DETAILED DESCRIPTION

Various embodiments are described with regard to a network device and/or a user equipment (UE). However, reference to a UE is merely provided for illustrative purposes. The example embodiments may be utilized with any electronic component that may establish a connection to a network and is configured with the hardware, software, and/or firmware to exchange information and data with a network. Therefore, the UE as described herein is used to represent any appropriate electronic device. Similarly, various embodiments are described with regard to a network device, which may be a network access point, a base station, and/or a relay deployed in a terrestrial network (TN), a satellite, and/or a high-altitude platform system (HAPS) including manned or unmanned aerial vehicles, and so on.

For a UE that is connected to a serving network device in a serving cell that is in a non-terrestrial network (NTN), and its handover from the serving cell to a target cell that is also in an NTN, timing requirements for a first uplink (UL) transmission are described in a table 7.1.C.2-1 of 3GPP TS 38.133. The first UL transmission may include any of a physical uplink control channel (PUCCH) transmission, a physical uplink shared channel (PUSCH) transmission, a sounding reference signal (SRS) transmission, a physical random-access channel (PRACH), and so on, in the target cell of the UE after handover of the UE. The timing requirements for the first UL transmission described in the table 7.1.C.2-1 of the 3GPP TS 38.133 are applicable to a frequency range 1 (FR1) only, and not to other frequency ranges including a frequency range 2 (FR2). In addition, the handover of the UE from the serving cell in an NTN to the target cell in the NTN requires the UE to perform a random-access channel (RACH) procedure and the requirements specified in the 3GPP TS 38.133 focus on an UL transmission.

The DL transmission may include, or may be based on, a DL synchronization, which DL synchronization may be skipped when the target cell is known. However, conditions to determine whether the target cell is known may not be appropriate for handover of the serving cell in an NTN and the target cell also in the NTN. In addition, a target network device in the target cell in the NTN is continuously moving, whether the target cell is known also depends on ephemeris information of the target cell with respect to the UE and/or a serving network device in a serving cell. Accordingly, various embodiments in the present disclosure describe how to identify whether a target cell is known or unknown for performing RACH-less handover and/or for performing (or skipping) a DL synchronization in the target cell for handover.

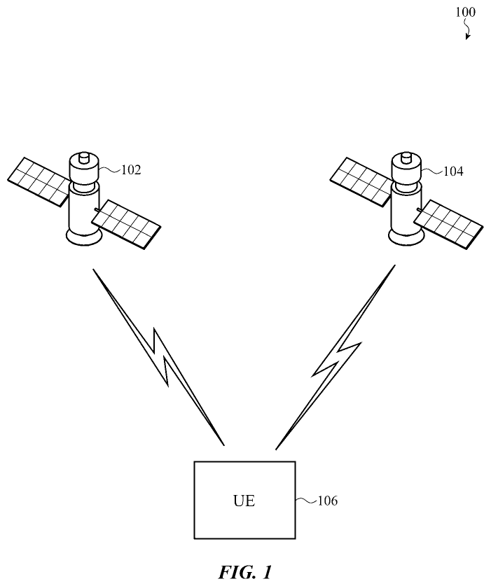

FIG. 1 shows a communication system including a user equipment in communication with multiple network devices. A communication system 100 shown in FIG. 1 includes a UE 106 and network devices 102 and 104. The UE 106 may be in communication with the network device 102. The network device 102 may be positioned in a satellite, which may be a satellite orbiting in a geosynchronous orbit (GSO). Accordingly, a serving cell of the UE 106 may be a GSO type based on a type of a satellite, in which the network device 102 is positioned, being a GSO satellite. Since the network device 102 is continuously moving, the UE may need to be handed over to another network device, for example, the network device 104 in a target cell, which may be positioned in a satellite, which may be a satellite orbiting in a GSO. Accordingly, a target cell of the UE 106 may be a GSO type based on the type of a satellite, in which the network device 104 is positioned, being a GSO satellite. Alternatively, or additionally, the serving cell or the target cell may be of a non-GSO (N-GSO) type. Embodiments described herein discusses how to determine a status of the target cell is known or unknown, and/or perform a DL synchronization for a RACH-less handover based on the status of the target cell.

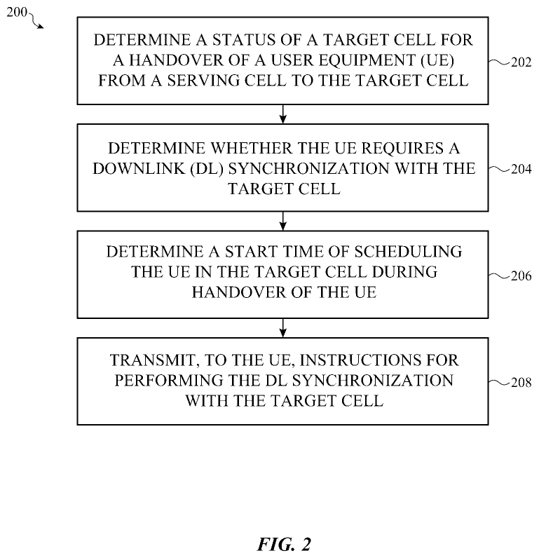

FIG. 2 shows an example method performed by a network device for performing a handover of a user equipment (UE), in accordance with some embodiments. As shown in a flow-chart 200 of FIG. 2, at 202, a network device, which may be a network device in a radio access network (RAN) and/or a core network (CN), may determine a status of a target cell for handover of a UE from a serving network device in a serving cell to a target network device in the target cell. By way of a non-limiting example, whether the status of the target cell is known or unknown is determined based on a satellite type of a satellite of the target cell, or a satellite type of a satellite in which a target network device is positioned, and in response to the UE meeting a cell identification requirement for a particular time duration.

In some embodiments, if the satellite in which the target network device is positioned is in a geosynchronous orbit (GSO) then a type of the target satellite is a GSO type satellite (or a GSO type, or a type GSO), then the status of the target cell may be considered as a known status in accordance the UE meeting a cell identification requirement for a particular time duration. In one example, the particular time duration may be a last X seconds, such as the last 5 seconds. As described herein, the cell identification requirement may include reporting a valid layer-3 (L3) measurement results for the target to the network (e.g., a RAN or a CN).

In some embodiments, if the satellite in which the target network device is positioned is in a non-geosynchronous orbit (N-GSO) then a type of the target satellite is a N-GSO type satellite (or a N-GSO type, or a type N-GSO), then the status of the target cell may be considered as a known status in accordance the UE meeting a cell identification requirement for a particular time duration. In one example, the particular time duration may be less than a last X seconds, such as less than the last 5 seconds. As described herein, the cell identification requirement may include reporting a valid layer-3 (L3) measurement results for the target to the network (e.g., a RAN or a CN).

Alternatively, or additionally, the status of the target cell may be considered as a known status for an N-GSO type satellite (or an N-GSO type target satellite) in accordance the UE meeting a cell identification requirement for a particular time duration determined based on a velocity of the N-GSO type target satellite and/or an ephemeris information of the target satellite. The ephemeris information of the target satellite may include an elevation angle (and/or an elevation angle compensation factor) of the target satellite and/or a velocity of the target satellite. Accordingly, in some embodiments, and by way of a non-limiting example, the particular time duration may be less than a last X seconds, where X is CP*C/satellite_velocity, CP is a cyclic prefix, and C is a speed of light. Alternatively, the particular time duration may be less than a last X seconds, where X is CP*C/(satellite_velocity+P), CP is a cyclic prefix, C is a speed of light, and P is an elevation angle compensation factor.

In some embodiments, if a serving network device and a target network device are both in a single satellite (of a GSO type or an N-GSO type), then the status of the target satellite may be considered as a known status. In other words, for an intra-satellite handover of the UE, the status of the target satellite may be considered as a known status irrespective of whether the UE meets or does not meet a cell identification requirement.

In some embodiments, if a target network device is in an N-GSO type target satellite, then the status of the target satellite may be considered as an unknown status. Alternatively, the status of the target satellite may be considered as an unknown status disregarding a type of a target satellite.

At 204, the network device may determine whether the UE requires a DL synchronization with the target cell in accordance with the determined status of the target cell. By way of a non-limiting example, if the status of the target cell is a known status, then the network device may determine the UE does not require a DL synchronization with the target cell.

At 206, the network device may determine a start time of scheduling the UE in the target cell. The handover of the UE from the serving cell to the target cell is performed without a RACH procedure. The start time of scheduling the UE may be associated with scheduling the UE for an UL transmission from the UE and/or a DL transmission to the UE.

At 208, based on the start time of scheduling the UE in the target cell determined at 206, the network device may transmit, to the UE, instructions for performing the DL synchronization with the target network device in the target cell. By way of a non-limiting example, the instructions transmitted to the UE may indicate the UE to perform the DL synchronization (requiring the UE to reserve a cell search time period), or skip the DL synchronization (requiring the UE not to reserve a cell search time period). As described herein, the UE may be instructed to skip the DL synchronization if the status of the target cell is determined as a known status, and the UE may be instructed to perform the DL synchronization if the status of the target cell is determined as an unknown status.

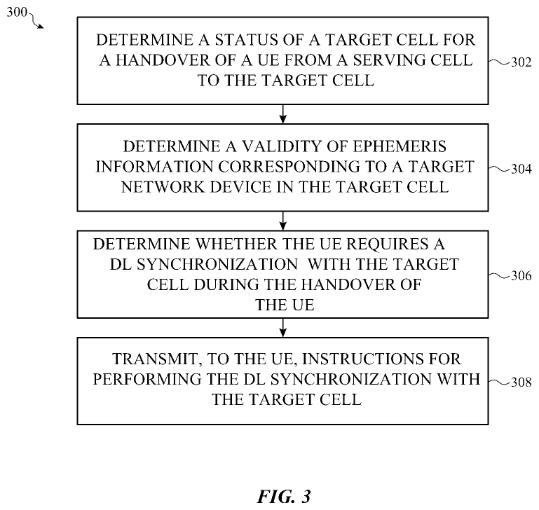

Additionally, or alternatively, whether a UE requires a DL synchronization may be determined based on a status of a target cell (e.g., a known status of a target status, or an unknown status of a target cell) and a validity of an ephemeris information as shown in FIG. 3, which describes another example method performed by a network device for handover of the UE, in accordance with some embodiments. As shown in a flow-char 300, at 302, a network device similar to a network device referenced herein using FIG. 2 may determine a status of a target cell for handover of a UE from a serving network device in a serving cell to a target network device in the target cell. The status of the target cell is determined as described herein using FIG. 2 with reference to 202 above, those details are not repeated here again for brevity.

At 304, the network device may determine a validity of an ephemeris information corresponding to the target network device in the target cell. By way of a non-limiting example, the validity of the ephemeris information may be determined using an ephemeris validity timer and its status (e.g., the ephemeris validity timer is still running, or the ephemeris validity timer has expired) at a time a handover command is transmitted to the UE (or received by the UE).

At 306, in accordance with the status of the target cell determined at 302 and the validity of the ephemeris information determined at 304, the network device may determine whether the UE requires a downlink (DL) synchronization with the target cell for the UE handover from the serving cell to the target cell without performing a RACH procedure. As described herein, if the status of the target cell is a known status, and the ephemeris information corresponding to the target network device (or the target cell) being still a valid ephemeris information, the network device may determine that no DL synchronization is required for the UE with the target cell. If the status of the target cell is a known status, and the ephemeris information corresponding to the target network device (or the target cell) is determined to be an invalid ephemeris information, the network device may determine that a DL synchronization is required for the UE with the target cell.

At 308, the network device may transmit, to the UE, instructions for performing the DL synchronization with the target network device in the target cell (or performing the DL synchronization with the target cell).

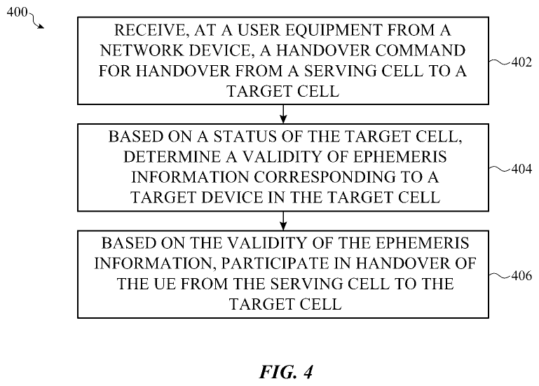

FIG. 4 shows an example method performed by a UE for a handover of the UE, in accordance with some embodiments. In particular, a flow-chart 400 shown in FIG. 4 describes operations performed by a UE, which operations may be performed during a UE handover based on a known or an unknown status of a target cell and/or a validity of ephemeris information corresponding to the target network device in the target cell. At 402, a handover command may be received at a UE from a network device in an NTN serving cell. The handover command may be associated with a handover of the UE from a serving network device to a target network device, and both of the serving network device and the target network device may be in an NTN. Alternatively, or additionally, the serving network device and/or the target network device may be in a high-altitude platform system (HAPS).

At 404, in accordance with the NTN target cell (or the target cell in the NTN) being a known target cell, the UE may determine a validity of ephemeris information corresponding to the target network device in the NTN target cell. A status of the NTN target cell may be determined as described herein using FIG. 2, and accordingly those details are not repeated here for brevity. Alternatively, or additionally, if the NTN target cell is determined as an unknown target cell, the validity of the ephemeris information may be determined as an invalid.

At 406, based on the determined validity of the ephemeris information, participate in a handover of the UE from the serving network device to the target network device. Accordingly, if the validity of the ephemeris information is determined being a valid ephemeris information (and the status of the target cell being a known target cell), the UE may perform or participate in a handover from the serving network device to the target network device (or from the serving cell to the target cell) without perform a RACH procedure. Similarly, if the validity of the ephemeris information is determined being an invalid ephemeris information (and the status of the target cell being a known target cell or an unknown target cell), the UE may perform or participate in a handover from the serving network device to the target network device (or from the serving cell to the target cell) by performing a RACH procedure.

Additionally, or alternatively, in some embodiments, if the validity of the ephemeris information is determined being an invalid ephemeris information (and the status of the target cell being a known target cell), the UE may update an ephemeris information corresponding to the serving cell (or the target cell) by performing a system information block type 19 (SIB-type 19) reading on the serving cell (or the target cell).

Additionally, or alternatively, in some embodiments, if the validity of the ephemeris information is determined being an invalid ephemeris information (and the status of the target cell being a known target cell), the UE may extend a validity timer of the ephemeris information, and perform or participate in the handover from the serving network device to the target network device (or from the serving cell to the target cell) without performing a RACH procedure.

Additionally, or alternatively, in some embodiments, if the validity of the ephemeris information is determined being an invalid ephemeris information (and the status of the target cell being a known target cell), the UE may trace back the ephemeris information, and perform or participate in the handover from the serving network device to the target network device (or from the serving cell to the target cell) without performing a RACH procedure. Tracing back the ephemeris information may be interpreted herein as using an epoch timing to trace back or identify a target satellite's location corresponding to a reception from or a transmission to the target satellite during the handover of the UE. By way of a non-limiting example, if the UE received a handover command at a time T1, and an epoch timing of a new and valid ephemeris information is applied at a time T1+n, the UE may trace back or identify the target satellite's location corresponding to the reception from or the transmission to the target satellite during the handover of the UE.

Embodiments contemplated herein include an apparatus having means to perform one or more elements of the method 200, 300, or 400. In the context of method 400, the apparatus may be, for example, an apparatus of a UE (such as a wireless device 602 that is a UE, as described herein). In the context of method 200 or 300, the apparatus may be, for example, an apparatus of a network device (such as a network device 620 that is a network access point or a base station, as described herein).

Embodiments contemplated herein include one or more non-transitory computer-readable media storing instructions to cause an electronic device, upon execution of the instructions by one or more processors of the electronic device, to perform one or more elements of the method 200, 300 or 400. In the context of method 400, the non-transitory computer-readable media may be, for example, a memory of a UE (such as a memory 606 of a wireless device 602 that is a UE, as described herein). In the context of method 200 or 300, the non-transitory computer-readable media may be, for example, a memory of a network device (such as a memory 624 of a network device 620 that is a network access point or a base station, as described herein).

Embodiments contemplated herein include an apparatus that has logic, modules, or circuitry to perform one or more elements of the method 200, 300 or 400. In the context of method 400, the apparatus may be, for example, an apparatus of a UE (such as a wireless device 602 that is a UE, as described herein). In the context of method 200 or 300, the apparatus may be, for example, an apparatus of a network device (such as a network device 620 that is a network access point or a base station, as described herein).

Embodiments contemplated herein include an apparatus having one or more processors and one or more computer-readable media, using, or storing instructions that, when executed by the one or more processors, cause the one or more processors to perform one or more elements of the method 200, 300 or 400. In the context of method 400, the apparatus may be, for example, an apparatus of a UE (such as a wireless device 602 that is a UE, as described herein). In the context of the method 200 or 300, the apparatus may be, for example, an apparatus of a network device (such as a network device 620 that is a network access point or a base station, as described herein).

Embodiments contemplated herein include a signal as described in or related to one or more elements of the method 200, 300 or 400.

Embodiments contemplated herein include a computer program or computer program product that has instructions, wherein execution of the program by a processor causes the processor to carry out one or more elements of the method 200, 300 or 400. In the context of method 400, the processor may be a processor of a UE (such as a processor(s) 604 of a wireless device 602 that is a UE, as described herein), and the instructions may be, for example, located in the processor and/or on a memory of the UE (such as a memory 606 of a wireless device 602 that is a UE, as described herein). In the context of method 200 or 300, the processor may be a processor of a network device (such as a processor(s) 622 of a network device 620 that is a network access point or a base station, as described herein), and the instructions may be, for example, located in the processor and/or on a memory of the network device (such as a memory 624 of a network device 620 that is a network access point or a base station, as described herein).

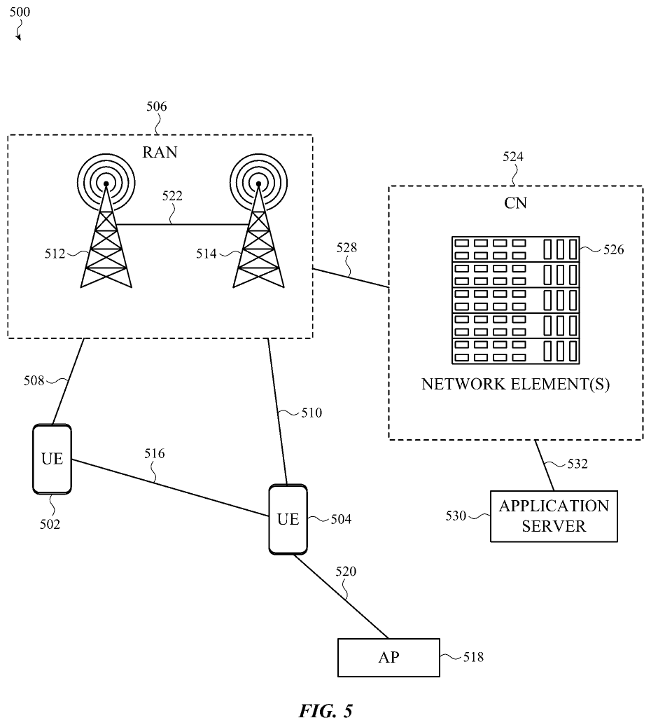

FIG. 5 illustrates an example architecture of a wireless communication system 500, according to embodiments disclosed herein. The following description is provided for an example wireless communication system 500 that operates in conjunction with the LTE system standards and/or 5G or NR system standards as provided by 3GPP technical specifications.

As shown by FIG. 5, the wireless communication system 500 includes UE 502 and UE 504 (although any number of UEs may be used). In this example, the UE 502 and the UE 504 are illustrated as smartphones (e.g., handheld touchscreen mobile computing devices connectable to one or more cellular networks), but may also comprise any mobile or non-mobile computing device configured for wireless communication.

The UE 502 and UE 504 may be configured to communicatively couple with a RAN 506. In embodiments, the RAN 506 may be NG-RAN, E-UTRAN, and so on. The UE 502 and UE 504 utilize connections (or channels) (shown as connection 508 and connection 510, respectively) with the RAN 506, each of which comprises a physical communications interface. The RAN 506 can include one or more base stations, such as base station 512 and base station 514, that enable the connection 508 and connection 510. In some embodiments, the RAN 506 may include one or more relays.

In this example, the connection 508 and connection 510 are air interfaces to enable such communicative coupling, and may be consistent with RAT(s) used by the RAN 506, such as, for example, an LTE and/or NR.

In some embodiments, the UE 502 and UE 504 may also directly exchange communication data via a sidelink interface 516. The UE 504 is shown to be configured to access an access point (shown as AP 518) via connection 520. By way of example, the connection 520 can comprise a local wireless connection, such as a connection consistent with any IEEE 802.11 protocol, wherein the AP 518 may comprise a Wi-Fi® router. In this example, the AP 518 may be connected to another network (for example, the Internet) without going through a CN 524.

In embodiments, the UE 502 and UE 504 can be configured to communicate using orthogonal frequency division multiplexing (OFDM) communication signals with each other or with the base station 512 and/or the base station 514 over a multicarrier communication channel in accordance with various communication techniques, such as, but not limited to, an orthogonal frequency division multiple access (OFDMA) communication technique (e.g., for downlink communications) or a single carrier frequency division multiple access (SC-FDMA) communication technique (e.g., for uplink and ProSe or sidelink communications), although the scope of the embodiments is not limited in this respect. The OFDM signals can comprise a plurality of orthogonal subcarriers.

In some embodiments, all, or parts of the base station 512 or base station 514 may be implemented as one or more software entities running on server computers as part of a virtual network. In addition, or in other embodiments, the base station 512 or base station 514 may be configured to communicate with one another via interface 522. In embodiments where the wireless communication system 500 is an LTE system (e.g., when the CN 524 is an EPC), the interface 522 may be an X2 interface. The X2 interface may be defined between two or more base stations (e.g., two or more eNBs and the like) that connect to an EPC, and/or between two eNBs connecting to the EPC. In embodiments where the wireless communication system 500 is an NR system (e.g., when CN 524 is a 5GC), the interface 522 may be an Xn interface. The Xn interface is defined between two or more base stations (e.g., two or more gNBs and the like) that connect to 5GC, between a base station 512 (e.g., a gNB) connecting to 5GC and an eNB, and/or between two eNBs connecting to 5GC (e.g., CN 524).

The RAN 506 is shown to be communicatively coupled to the CN 524. The CN 524 may comprise one or more network elements 526, which are configured to offer various data and telecommunications services to customers/subscribers (e.g., users of UE 502 and UE 504) who are connected to the CN 524 via the RAN 506. The components of the CN 524 may be implemented in one physical device or separate physical devices including components to read and execute instructions from a machine-readable or computer-readable medium (e.g., a non-transitory machine-readable storage medium).

In embodiments, the CN 524 may be an EPC, and the RAN 506 may be connected with the CN 524 via an S1 interface 528. In embodiments, the S1 interface 528 may be split into two parts, an S1 user plane (S1-U) interface, which carries traffic data between the base station 512 or base station 514 and a serving gateway (S-GW), and the S1-MME interface, which is a signaling interface between the base station 512 or base station 514 and mobility management entities (MMEs).

In embodiments, the CN 524 may be a 5GC, and the RAN 506 may be connected with the CN 524 via an NG interface 528. In embodiments, the NG interface 528 may be split into two parts, an NG user plane (NG-U) interface, which carries traffic data between the base station 512 or base station 514 and a user plane function (UPF), and the S1 control plane (NG-C) interface, which is a signaling interface between the base station 512 or base station 514 and access and mobility management functions (AMFs).

Generally, an application server 530 may be an element offering applications that use internet protocol (IP) bearer resources with the CN 524 (e.g., packet switched data services). The application server 530 can also be configured to support one or more communication services (e.g., VoIP sessions, group communication sessions, and so on.) for the UE 502 and UE 504 via the CN 524. The application server 530 may communicate with the CN 524 through an IP communications interface 532.

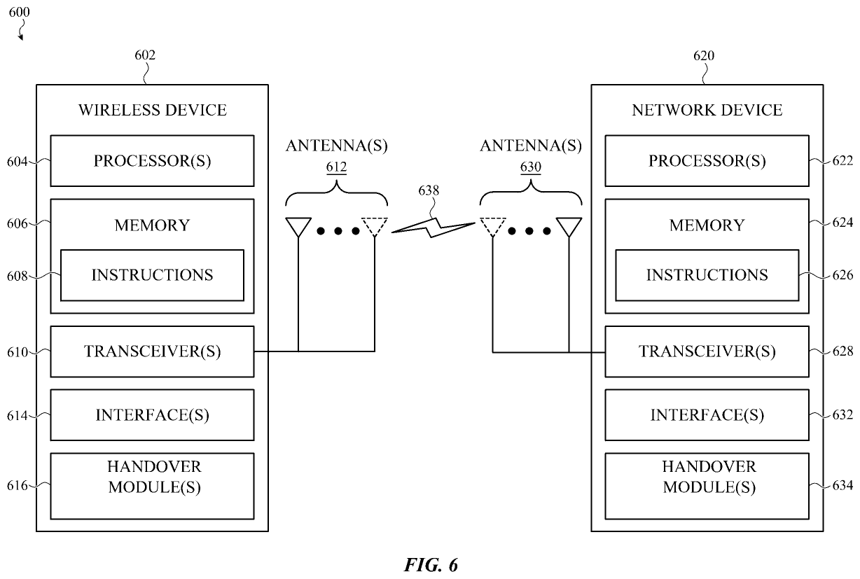

FIG. 6 illustrates a system 600 for performing signaling 638 between a wireless device 602 and a network device 620, according to embodiments disclosed herein. The system 600 may be a portion of a wireless communication system as herein described. The wireless device 602 may be, for example, a UE of a wireless communication system. The network device 620 may be, for example, a base station (e.g., an eNB or a gNB), or a relay of a wireless communication system.

The wireless device 602 may include one or more processor(s) 604. The processor(s) 604 may execute instructions such that various operations of the wireless device 602 are performed, as described herein. The processor(s) 604 may include one or more baseband processors implemented using, for example, a central processing unit (CPU), a digital signal processor (DSP), an application specific integrated circuit (ASIC), a controller, a field programmable gate array (FPGA) device, another hardware device, a firmware device, or any combination thereof configured to perform the operations described herein.

The wireless device 602 may include a memory 606. The memory 606 may be a non-transitory computer-readable storage medium that stores instructions 608 (which may include, for example, the instructions being executed by the processor(s) 604). The instructions 608 may also be referred to as program code or a computer program. The memory 606 may also store data used by, and results computed by, the processor(s) 604.

The wireless device 602 may include one or more transceiver(s) 610 that may include radio frequency (RF) transmitter and/or receiver circuitry that use the antenna(s) 612 of the wireless device 602 to facilitate signaling (e.g., the signaling 640) to and/or from the wireless device 602 with other devices (e.g., the network device 620) according to corresponding RATs.

The wireless device 602 may include one or more antenna(s) 612 (e.g., one, two, four, or more). For embodiments with multiple antenna(s) 612, the wireless device 602 may leverage the spatial diversity of such multiple antenna(s) 612 to send and/or receive multiple different data streams on the same time and frequency resources. This behavior may be referred to as, for example, multiple input multiple output (MIMO) behavior (referring to the multiple antennas used at each of a transmitting device and a receiving device that enable this aspect). MIMO transmissions by the wireless device 602 may be accomplished according to precoding (or digital beamforming) that is applied at the wireless device 602 that multiplexes the data streams across the antenna(s) 612 according to known or assumed channel characteristics such that each data stream is received with an appropriate signal strength relative to other streams and at a desired location in the spatial domain (e.g., the location of a receiver associated with that data stream).

Certain embodiments may use single user MIMO (SU-MIMO) methods (where the data streams are all directed to a single receiver) and/or multiuser MIMO (MU-MIMO) methods (where individual data streams may be directed to individual (different) receivers in different locations in the spatial domain).

In certain embodiments that have multiple antennas, the wireless device 602 may implement analog beamforming techniques, whereby phases of the signals sent by the antenna(s) 612 are relatively adjusted such that the (joint) transmission of the antenna(s) 612 can be directed (this is sometimes referred to as beam steering).

The wireless device 602 may include one or more interface(s) 614. The interface(s) 614 may be used to provide input to or output from the wireless device 602. For example, a wireless device 602 that is a UE may include interface(s) 614 such as microphones, speakers, a touchscreen, buttons, and the like in order to allow for input and/or output to the UE by a user of the UE. Other interfaces of such a UE may be made up of transmitters, receivers, and other circuitry (e.g., other than the transceiver(s) 610/antenna(s) 612 already described) that allow for communication between the UE and other devices and may operate according to known protocols (e.g., Wi-Fi®, Bluetooth®, and the like).

The wireless device 602 may include one or more handover module(s) 616. The handover module(s) 616 may be implemented via hardware, software, or combinations thereof. For example, the handover module(s) 616 may be implemented as a processor, circuit, and/or instructions 608 stored in the memory 606 and executed by the processor(s) 604. In some examples, the handover module(s) 616 may be integrated within the processor(s) 604 and/or the transceiver(s) 610. For example, the handover module(s) 616 may be implemented by a combination of software components (e.g., executed by a DSP or a general processor) and hardware components (e.g., logic gates and circuitry) within the processor(s) 604 or the transceiver(s) 610.

The handover module(s) 616 may be used for various aspects of the present disclosure, for example, aspects of FIGS. 1-4, from a UE perspective.

The network device 620 may include one or more processor(s) 622. The processor(s) 622 may execute instructions such that various operations of the network device 620 are performed, as described herein. The processor(s) 604 may include one or more baseband processors implemented using, for example, a CPU, a DSP, an ASIC, a controller, an FPGA device, another hardware device, a firmware device, or any combination thereof configured to perform the operations described herein.

The network device 620 may include a memory 624. The memory 624 may be a non-transitory computer-readable storage medium that stores instructions 626 (which may include, for example, the instructions being executed by the processor(s) 622). The instructions 626 may also be referred to as program code or a computer program. The memory 624 may also store data used by, and results computed by, the processor(s) 622.

The network device 620 may include one or more transceiver(s) 628 that may include RF transmitter and/or receiver circuitry that use the antenna(s) 630 of the network device 620 to facilitate signaling (e.g., the signaling 638) to and/or from the network device 620 with other devices (e.g., the wireless device 602) according to corresponding RATs.

The network device 620 may include one or more antenna(s) 630 (e.g., one, two, four, or more). In embodiments that have multiple antenna(s) 630, the network device 620 may perform MIMO, digital beamforming, analog beamforming, beam steering, and so on, as has been described.

The network device 620 may include one or more interface(s) 632. The interface(s) 632 may be used to provide input to or output from the network device 620. For example, a network device 620 that is a base station may include interface(s) 632 made up of transmitters, receivers, and other circuitry (e.g., other than the transceiver(s) 628/antenna(s) 630 already described) that enables the base station to communicate with other equipment in a core network, and/or that enables the base station to communicate with external networks, computers, databases, and the like for purposes of operation, administration, and maintenance of the base station or other equipment operably connected thereto.

The network device 620 may include one or more handover module(s) 634. The handover module(s)) 634 may be implemented via hardware, software, or combinations thereof. For example, the handover module(s) 634 may be implemented as a processor, circuit, and/or instructions 626 stored in the memory 624 and executed by the processor(s) 622. In some examples, the handover module(s) 634 may be integrated within the processor(s) 622 and/or the transceiver(s) 628. For example, the handover module(s) 634 may be implemented by a combination of software components (e.g., executed by a DSP or a general processor) and hardware components (e.g., logic gates and circuitry) within the processor(s) 622 or the transceiver(s) 628.

The handover module(s) 634 may be used for various aspects of the present disclosure, for example, aspects of FIGS. 1-4, from a network device perspective.

For one or more embodiments, at least one of the components set forth in one or more of the preceding figures may be configured to perform one or more operations, techniques, processes, and/or methods as set forth herein. For example, a baseband processor as described herein in connection with one or more of the preceding figures may be configured to operate in accordance with one or more of the examples set forth herein. For another example, circuitry associated with a UE, base station, network element, and so on. as described above in connection with one or more of the preceding figures may be configured to operate in accordance with one or more of the examples set forth herein.

Any of the above-described embodiments may be combined with any other embodiment (or combination of embodiments), unless explicitly stated otherwise. The foregoing description of one or more implementations provides illustration and description, but is not intended to be exhaustive or to limit the scope of embodiments to the precise form disclosed. Modifications and variations are possible in light of the above teachings or may be acquired from practice of various embodiments.

Embodiments and implementations of the systems and methods described herein may include various operations, which may be embodied in machine-executable instructions to be executed by a computer system. A computer system may include one or more general-purpose or special-purpose computers (or other electronic devices). The computer system may include hardware components that include specific logic for performing the operations or may include a combination of hardware, software, and/or firmware.

It should be recognized that the systems described herein include descriptions of specific embodiments. These embodiments can be combined into single systems, partially combined into other systems, split into multiple systems, or divided or combined in other ways. In addition, it is contemplated that parameters, attributes, aspects, and so on. of one embodiment can be used in another embodiment. The parameters, attributes, aspects, and so on. are merely described in one or more embodiments for clarity, and it is recognized that the parameters, attributes, aspects, etc. can be combined with or substituted for parameters, attributes, aspects, etc. of another embodiment unless specifically disclaimed herein.

It is well understood that the use of personally identifiable information should follow privacy policies and practices that are generally recognized as meeting or exceeding industry or governmental requirements for maintaining the privacy of users. In particular, personally identifiable information data should be managed and handled so as to minimize risks of unintentional or unauthorized access or use, and the nature of authorized use should be clearly indicated to users.

Although the foregoing has been described in some detail for purposes of clarity, it will be apparent that certain changes and modifications may be made without departing from the principles thereof. It should be noted that there are many alternative ways of implementing both the processes and apparatuses described herein. Accordingly, the present embodiments are to be considered illustrative and not restrictive, and the description is not to be limited to the details given herein, but may be modified within the scope and equivalents of the appended claims.

1. An apparatus comprising memory coupled to a processor, the processor configured to:
determine a status of a target cell for handover of a user equipment (UE) from a serving network device in a serving cell to a target network device in the target cell, the serving cell and the target cell are in a non-terrestrial network (NTN);
in accordance with the determined status of the target cell, determine,
whether the UE requires a downlink (DL) synchronization with the target cell; and
a start time of scheduling the UE in the target cell without the UE performing random access channel (RACH) procedure during handover of the UE from the serving cell to the target cell; and
transmit, to the UE, and based on the determined start time of scheduling the UE in the target cell, instructions for performing the DL synchronization with the target network device in the target cell.

2. The apparatus of claim 1, wherein the status of the target cell is determined as a known target cell or an unknown target cell.

3. The apparatus of claim 2, wherein:
the known target cell status is determined based on a satellite type of a satellite of the target cell and in response to the UE meeting a cell identification requirement for a particular time duration; and
the satellite is orbiting in a geosynchronous orbit (GSO) or a non-geosynchronous orbit (N-GSO).

4. The apparatus of claim 3, wherein:
the cell identification requirement includes a valid level-3 radio resource management (RRM) measurement for the particular time duration; and
the particular time duration for the satellite in the GSO is a last 5 seconds.

5. The apparatus of claim 3, wherein:
the cell identification requirement includes a valid level-3 (L3) radio resource management (RRM) measurement for the particular time duration; and
the particular time duration for the satellite in the N-GSO is less than a last 5 seconds.

6. The apparatus of claim 3, wherein:
the cell identification requirement includes a valid level-3 (L3) radio resource management (RRM) measurement for the particular time duration; and
the particular time duration for the satellite in the N-GSO is determined based on a velocity of a satellite in the target cell or an elevation angle compensation factor corresponding to the target cell.

7. The apparatus of claim 2, wherein:
the known target cell status is determined in response to the serving network device and the target network device being in a single satellite orbiting in a geosynchronous orbit (GSO) or a non-geosynchronous orbit (N-GSO).

8. The apparatus of claim 2, wherein:
the known target cell status is determined in response to the UE meeting a cell identification requirement for a particular time duration;
the cell identification requirement includes a valid level-3 (L3) radio resource management (RRM) measurement for the particular time duration; and
the particular time duration is less than a last 5 seconds.

9. The apparatus of claim 2, wherein:
the unknown target cell status is determined based on a satellite type of a satellite of the target cell; and
the satellite type is a non-geosynchronous orbit (N-GSO) satellite type.

10. The apparatus of claim 1, wherein:
the processor is further configured to transmit, to the UE, and in response to determining the status of the target cell as a known target cell for the UE, the instructions indicating not to perform DL synchronization for the UE with the target network device.

11. The apparatus of claim 1, wherein:
the processor is further configured to transmit, to the UE, and in response to determining the status of the target cell as an unknown target cell for the UE, the instructions indicating to perform DL synchronization is required for the UE with the target network device.

12. An apparatus comprising memory coupled to a processor, the processor configured to:
determine a status of a target cell for handover of a user equipment (UE) from a serving network device in a serving cell to a target network device in the target cell, the serving cell and the target cell are in a non-terrestrial network (NTN);
determine a validity of ephemeris information corresponding to the target network device in the target cell;
in accordance with the determined status of the target cell and the determined validity of the ephemeris information corresponding to the target network device in the target cell, determine whether the UE requires a downlink (DL) synchronization with the target cell during handover of the UE from the serving cell to the target cell without the UE performing a random-access channel (RACH) procedure; and
transmit, to the UE, instructions for performing the DL synchronization with the target network device in the target cell.

13. The apparatus of claim 12, wherein:
the determined status of the target cell for handover of the UE is a known target cell; and
the validity of the ephemeris information corresponding to the target network device is determined as expired; and
the processor is further configured to transmit, to the UE, the instructions indicating DL synchronization is required for the UE with the target network device and perform the RACH procedure during handover of the UE from the serving cell to the target cell.

14. An apparatus comprising memory coupled to a processor, the processor configured to:
receive, from a network device in a non-terrestrial network (NTN) serving cell, a handover command, the handover command associated with a handover of a user equipment (UE) from the network device to a target network device in an NTN target cell;
in accordance with the NTN target cell being a known target cell, determine a validity of ephemeris information corresponding to the target network device in the NTN target cell; and
based on the determined validity of the ephemeris information, participate in a handover of the UE from the serving network device to the target network device.

15. The apparatus of claim 14, wherein:
the validity of the ephemeris information corresponding to the target network device is determined as expired; and
for the handover of the UE, the processor is further configured to perform a random-access channel (RACH) procedure during handover of the UE from the serving cell to the target cell.

16. The apparatus of claim 14, wherein:
the validity of the ephemeris information corresponding to the target network device is determined as expired; and
for the handover of the UE, the processor is further configured to update ephemeris information corresponding to the serving cell by performing system information block type 19 reading on the serving cell.

17. The apparatus of claim 14, wherein:
the validity of the ephemeris information corresponding to the target network device is determined as expired; and
for the handover of the UE, the processor is further configured to extend a validity timer of the ephemeris information, and perform the handover without performing a random-access channel (RACH) procedure.

18. The apparatus of claim 14, wherein:
the validity of the ephemeris information corresponding to the target network device is determined as expired; and
for the handover of the UE, the processor is further configured to trace back the ephemeris information, and perform the handover without performing a random-access channel (RACH) procedure.

19. The apparatus of claim 14, wherein:
for the handover of the UE, the processor is further configured to perform downlink (DL) synchronization based on the validity of the ephemeris information corresponding to the target network device.

20. The apparatus of claim 14, wherein validity of the ephemeris information is determined based on ephemeris information and epoch timing.
